(19) United States
(12) Patent Application Publication
(10) Pub. No.: US 2025/0318469 A1
(43) Pub. Date: Oct. 16, 2025

(54) SUGARCANE HARVESTER WITH COOLING INLET DEBRIS REMOVAL SYSTEM

(71) Applicant: DEERE & COMPANY, MOLINE, IL (US)

(72) Inventors: Felipe Nascimento, Catalão (BR); Jae-Jae Young, Thibodaux, LA (US); Mahadev S. Pansare, PUNE (IN); RUSHIKESH DAKHORE, Risod (IN); SURFRAJ FATTEPUR, PUNE (IN); DUSK S. MIXON, Saint Amant, LA (US); Leonardo A. Rosa, Catalão (BR)

(21) Appl. No.: 19/044,711

(22) Filed: Feb. 4, 2025

Related U.S. Application Data
(60) Provisional application No. 63/632,687, filed on Apr. 11, 2024.

(51) Int. Cl. A01D 69/00; A01D 45/10; F01P 11/06

(52) U.S. Cl. CPC A01D 69/00; A01D 45/10; F01P 2011/061

(57) ABSTRACT

A sugarcane harvester includes a primary cooling system having a heat exchanger. The primary cooling system is operable to circulate a coolant through a power source for absorbing heat from the power source, and circulate a coolant through the heat exchanger for transferring heat from the coolant to a flow of cooling air moving across the heat exchanger. An inlet debris removal system includes an air pump and a nozzle. The air pump generates a flow of cleaning air. The nozzle receives the flow of cleaning air from the air pump and directs the flow of cleaning air across an inlet region of the heat exchanger for cleaning debris from the inlet region to maintain the flow of cooling air across the heat exchanger.

### CROSS-REFERENCE TO RELATED APPLICATIONS

This application claims the benefit of U.S. Provisional Patent Application Ser. No. 63/632,687, filed on Apr. 11, 2024, the disclosure of which is hereby incorporated by reference.

### TECHNICAL FIELD

The disclosure generally relates to a sugarcane harvester.

### BACKGROUND

Sugarcane harvesters often have a basecutter assembly positioned to sever sugarcane stalks adjacent a ground surface, and convey the sugarcane stalks to a chopper. The chopper cuts the sugarcane stalks into billets and ejects or discharges the billets into the air and towards an elevator. An extractor is positioned between the chopper and the elevator to induce a flow of air through the billets for removing unwanted leaf material and other debris from the flow of billets as the billets move through the air between the chopper and the elevator. A hood is disposed on the extractor, and is moveable to control a direction in which the leaf material is discharged from the extractor.

The sugarcane harvester is powered by a power source, e.g., an internal combustion engine, which may include an engine cooling system. The engine cooling system may include a radiator positioned adjacent an air inlet. A coolant is circulated through the power source and the radiator. The coolant absorbs heat from the power source thereby cooling and/or maintaining an operating temperature of the power source. Air passes through the air inlet and across/through the radiator, whereby heat is transferred from the coolant to the air, thereby removing heat from the coolant. Often the air inlet is disposed proximate the hood of the extractor. Leaf material discharged from the extractor may be drawn towards and accumulate on the air inlet, thereby reducing and/or blocking air flow through the air inlet, which in turn reduces or blocks air flow across/through the radiator.

### SUMMARY

A sugarcane harvester is provided. The sugarcane harvester includes a main frame, and a power source supported on the main frame. The power source is operable to generate torque to power the various components of the sugarcane harvester. A primary cooling system includes a heat exchanger, and is operable to circulate a coolant through the power source for absorbing heat from the power source, and circulate the coolant through the heat exchanger for transferring heat from the coolant to a flow of cooling air moving across the heat exchanger. The flow of cooling air moves from an inlet region of the heat exchanger, across and/or through the heat exchanger, to a discharge region of the heat exchanger. An inlet debris removal system includes an air pump and a nozzle. The air pump is operable to generate a flow of cleaning air. The nozzle is configured to receive the flow of cleaning air from the air pump and direct the flow of cleaning air across the inlet region of the heat exchanger for cleaning debris from the inlet region to maintain the flow of cooling air across the heat exchanger.

Accordingly, the inlet debris removal system is operable to prevent the accumulation of debris against the heat exchanger within the inlet region thereof, and/or remove any debris that may have accumulated against the heat exchanger in the inlet region of the heat exchanger. The debris may include, for example, excess leaf material that was discharged from the sugarcane harvester by an extractor. By preventing and/or removing debris from the inlet region of the heat exchanger, the flow of cooling air through the heat exchanger may be maintained, thereby enabling proper operation of the cooling system for cooling the power source.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1A is a schematic side view of a sugarcane harvester.

FIG. 1B is a schematic side view of the sugarcane harvester showing a primary cooling system and an inlet debris removal system.

FIG. 2 is a schematic partial perspective view of the sugarcane harvester showing an auxiliary air pump.

FIG. 3A is a schematic partial perspective view of the sugarcane harvester showing a first embodiment of a nozzle and a duct connecting the nozzle and the auxiliary air pump.

FIG. 3B is a schematic plan view of the first embodiment of the inlet debris removal system shown in FIG. 3A.

FIG. 4A is a schematic partial perspective view of the sugarcane harvester showing a second embodiment of the nozzle and the duct connecting the nozzle and the auxiliary air pump.

FIG. 4B is a schematic plan view of the second embodiment of the inlet debris removal system shown in FIG. 4A.

FIG. 5A is a schematic partial perspective view of the sugarcane harvester showing a third embodiment of the nozzle and the duct connecting the nozzle and the auxiliary air pump.

FIG. 5B is a schematic plan view of the third embodiment of the inlet debris removal system shown in FIG. 5A.

FIG. 6A is a schematic partial perspective view of the sugarcane harvester showing a fourth embodiment of the nozzle and the duct connecting the nozzle and the auxiliary air pump.

FIG. 6B is a schematic plan view of the fourth embodiment of the inlet debris removal system shown in FIG. 6A.

FIG. 7A is a schematic partial perspective view of the sugarcane harvester showing a fifth embodiment of the nozzle and the duct connecting the nozzle and the auxiliary air pump.

FIG. 7B is a schematic plan view of the fifth embodiment of the inlet debris removal system shown in FIG. 7A.

FIG. 8A is a schematic partial perspective view of the sugarcane harvester showing a sixth embodiment of the nozzle and the duct connecting the nozzle and the auxiliary air pump.

FIG. 8B is a schematic plan view of the sixth embodiment of the inlet debris removal system shown in FIG. 8A.

FIG. 9A is a schematic partial perspective view of the sugarcane harvester showing a seventh embodiment of the inlet debris removal system.

FIG. 9B is a schematic partial perspective view of the sugarcane harvester showing the nozzle of the seventh embodiment of the inlet debris removal system directing the flow of cleaning across a platform adjacent the inlet region.

FIG. 10A is a schematic partial perspective view of the sugarcane harvester showing an eight embodiment of the inlet debris removal system.

FIG. 10B is a schematic partial perspective view of the sugarcane harvester showing the nozzle of the eighth embodiment of the inlet debris removal system directing the flow of cleaning across the platform adjacent the inlet region.

FIG. 11 is a schematic partial perspective view of the air inlet screen showing a louver on a lower portion of the air inlet screen.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

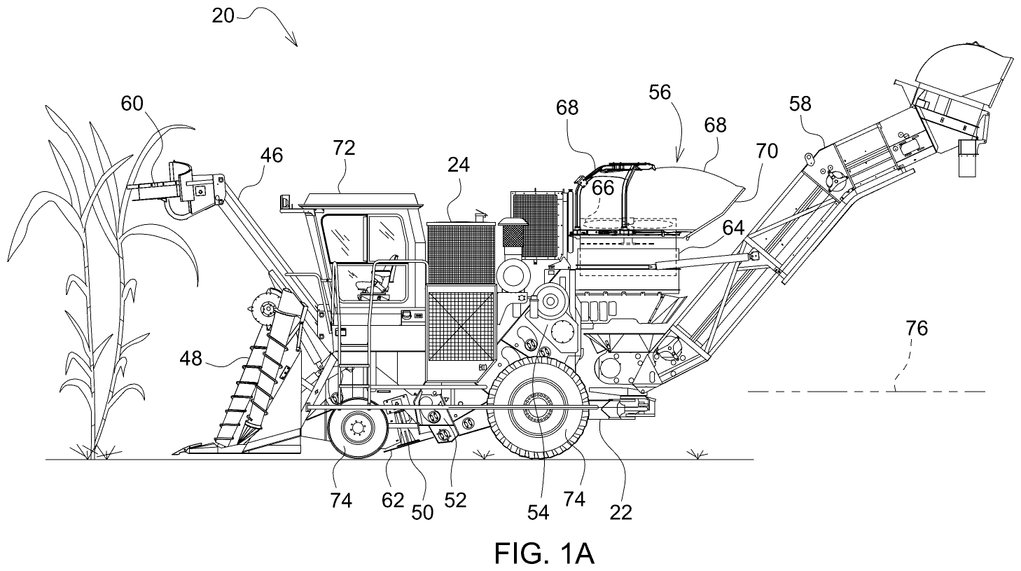

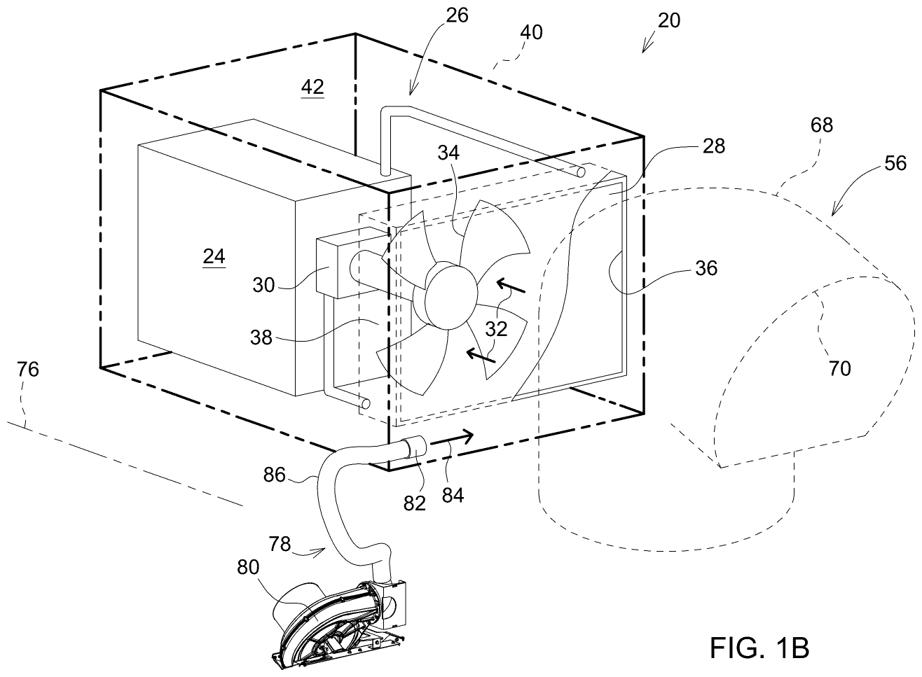

Referring to the Figures, wherein like numerals indicate like parts throughout the several views, a sugarcane harvester is generally shown at 20. Referring to FIG. 1, the sugarcane harvester 20 includes a main frame 22. The main frame 22 supports various cutting, routing and processing devices. A power source 24 is supported on the main frame 22. The power source 24 is operable to generate torque, which may be used to power the various cutting, routing and processing systems and devices of the sugarcane harvester 20. The power source 24 may include, but is not limited to, an internal combustion engine, an electric motor, or other similar torque generating device. In certain embodiments, the power source 24 may directly power a main hydraulic pump (not shown). Various driven components of the sugarcane harvester 20 may be powered by hydraulic motors receiving hydraulic power from the main hydraulic pump via one or more hydraulic loops (not shown).

Referring also to FIG. 1B, the sugarcane harvester 20 may further include a primary cooling system 26 for cooling and/or maintaining a temperature of the power source 24. The primary cooling system 26 may include, but is not limited, a heat exchanger 28 and associated coolant pump 30. The coolant pump 30 of the primary cooling system 26 is operable to circulate a coolant through the power source 24 and the heat exchanger 28. The coolant absorbs heat from the power source 24 while circulating through the power source 24. The coolant pump 30 further circulates the coolant through the heat exchanger 28 for transferring heat from the coolant to a flow of cooling air 32 moving across the heat exchanger 28. The heat exchanger 28 may be commonly referred to as a radiator. The primary cooling system 26 may further include a cooling fan 34. The cooling fan 34 is configured to move air across and through the heat exchanger 28. As is understood by those skilled in the art, the cooling fan 34 moves air through and/or across the heat exchanger 28 from an inlet region 36 toward a discharge region 38. The inlet region 36 may be considered an exterior of an engine bay 42, whereas the discharge region 38 may be considered an interior of the engine bay 42. As such, the cooling fan 34 may be configured to move air from outside the engine bay 42, through the heat exchanger 28, and onto and/or across the power source 24. The heat exchanger 28 transfers heat from the coolant to the flow of air, thereby cooling the coolant. The coolant circulates through the power source 24 and the heat exchanger 28 in a continuous loop as is understood by those skilled in the art. The particular features, components, and operation of the primary cooling system 26 are understood by those skilled in the art, are not pertinent to the teachings of this disclosure, and are therefore not described in greater detail herein.

The sugarcane harvester 20 may further include a main housing 40. The main housing 40 may include one or more panels arranged to cover one or more components of the sugarcane harvester 20. For example, the main housing 40 may include one or more panels arranged to define the engine bay 42 for covering the power source 24. The main housing 40 may further include and/or define an air inlet screen 44 positioned adjacent the heat exchanger 28. More particularly, the air inlet screen 44 of the main housing 40 may be positioned adjacent to and proximate the inlet region 36 of the heat exchanger 28. The air inlet screen 44 includes openings allowing air to pass through the main housing 40 for cooling the heat exchanger 28, while blocking larger debris from entering the engine bay 42.

Referring to FIG. 1, among other components and features, some of which are not described herein, the sugarcane harvester 20 may include a topper 46 assembly, a left and a right crop divider scroll 48 (the left crop divider scroll 48 is not shown), an upper knockdown roller and a lower knockdown roller (the upper and lower knockdown rollers are not shown), a basecutter assembly 50, a feed section 52, a chopping section or chopper 54, an extractor 56, and an elevator 58.

The topper 46 assembly is mounted to the main frame 22. The topper 46 assembly includes a cantilevered arm structure attached to the main frame 22. The cantilevered arm extends from the main frame 22 to a distal end thereof, in a generally forward direction relative to a direction of travel during harvest operations, and a generally upward direction relative to a ground surface. The topper 46 assembly includes a top cutter 60 supported by the cantilevered arm proximate the distal end of the cantilevered arm. The top cutter 60 is positioned for severing an upper leaf portion of a sugarcane plant from a central stalk portion of the sugarcane plant. The top cutter 60 may include a blade or other cutting device and/or system configured for cutting the sugarcane plant. The particular components, structure and operation of the top cutter 60 are understood by those skilled in the art, and are therefore not described in greater detail herein.

The left and right crop divider scrolls 48 are adapted to lift the sugarcane plants for feeding into a throat of the sugarcane harvester 20. The upper and lower knockdown rollers are adapted to lean standing sugarcane plants in the forward direction relative to the direction of travel of the sugarcane harvester 20 during operation.

The basecutter assembly 50 is mounted to the main frame 22 adjacent the ground surface. The basecutter assembly 50 includes a cutting disk 62 or other cutting device that is configured for severing the sugarcane plants adjacent the ground surface. The basecutter assembly 50 is operable to sever the central stalk portion of the sugarcane plant from a bottom root portion of the sugarcane plant. The basecutter assembly 50 is adapted to sever the sugarcane plants knocked down or leaned over in the forward direction by the upper and lower knockdown rollers. Additionally, the basecutter assembly 50 is operable to move and/or feed the central stalk portion of the sugarcane plant to the feed section 52.

The feed section 52 is adapted to receive a mat of severed sugarcane crop material from the basecutter assembly 50, and to move the mat of crop material rearwardly for further processing. The feed section 52 may include, for example, successive pairs of upper and lower feed rollers rotatably supported by the main frame 22. At least one pair of the upper and lower feed rollers may be powered to transport the mat of the cut sugarcane crop material to the chopper 54. The chopper 54 is adapted to receive the mat from the feed section 52 and to cut the sugarcane plant into billets. The chopper 54 may include, for example, a drum configured for cutting the stalks of sugarcane into billets.

The extractor 56 is positioned downstream from the chopper 54 and is adapted to separate debris, including, for example, crop residue (e.g., leafy material), from the billets and remove the debris from the sugarcane harvester 20. Referring to FIG. 1, the extractor 56 includes a fan housing 64 defining an interior passage extending along a central axis. The extractor 56 further includes a fan assembly 66 disposed and/or positioned within the interior passage of the fan housing 64. The fan assembly 66 includes one or more fan blades (e.g., four fan blades) mounted for rotation about the central axis in a direction of rotation of the fan blades. Rotation of the fan blades about the central axis induces a flow of air through the interior passage of the fan housing 64 of the fan assembly 66. The flow of air through the fan assembly 66 separates and extracts the leaf material from the flow of billets produced by the chopper 54. A hood 68 is attached to the fan housing 64 of the extractor 56. The hood 68 defines an exhaust outlet 70 through which the leaf material is discharged from the extractor 56. The hood 68 may be moveable relative to the main frame 22 for controlling the direction in which the leaf material is discharged from the sugarcane harvester 20. A rotator may be coupled to the hood 68 and operable to rotate the hood 68 relative to the main frame 22 to direct discharge of the extracted leaf material from the exhaust outlet 70.

The billets are airborne when discharged from the chopper 54 facilitating separation of the leaf material from the billets by the flow of air induced by the fan assembly 66. Referring to FIG. 1, the elevator 58 is positioned at the rear of the sugarcane harvester 20 to receive the cleaned flow of billets from the chopper 54, and is adapted to convey the billets to an elevated position where the billets are discharged into a transport vehicle to be hauled away. The elevator 58 is configured for lifting the sugarcane billets from a lower receiving elevation to an upper discharge elevation. As described above, once ejected from the chopper 54, gravity acts on the billets causing the billets to fall vertically downward as the extractor 56 removes the leaf material therefrom. The elevator 58 includes a lower receiving portion positioned to capture or catch the billets ejected from the chopper 54. The lower receiving portion of the elevator 58 is positioned lower in the sugarcane harvester 20 relative to the ground surface, at the lower receiving elevation, to provide a vertical distance between the primary extractor 56 and the lower receiving portion of the elevator 58 so that the billets separate, and the flow of air induced by the extractor 56 may operate to separate and/or remove the debris. The elevator 58 includes a lift portion extending upward from the lower receiving portion and away from the sugarcane harvester 20. The lift portion is arranged to raise or lift the billets to a higher elevation for discharge into a wagon for transport to a mill. As is understood in the art, the elevator 58 may include an elevator 58 structure that rotatably supports a conveyor, e.g., an endless device such as but not limited to a conveyor belt. The conveyor may include flighting or other similar structure to engage the billets and move the billets up the lift portion of the elevator 58.

Referring to FIG. 1, the sugarcane harvester 20 may include an operator station 72 and traction elements 74. The various user input and control devices, data output devices, etc., may be located within the operator station 72. A human operator may operate the sugarcane harvester 20 from the operator station 72. In certain embodiments, the main frame 22 may be supported by a transport frame such as track frame supporting the traction elements 74. The traction elements 74 are positioned on the left and right sides of the sugarcane harvester 20 for propelling the sugarcane harvester 20 through a field and along the ground surface. Each traction element may include, but is not limited to, a track unit or a ground-engaging wheel.

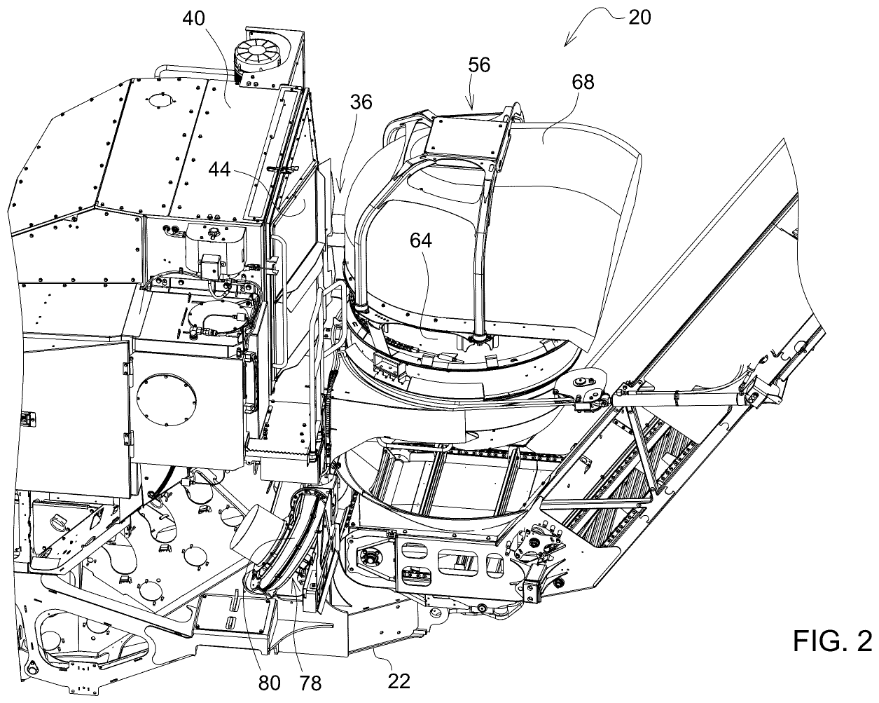

Referring also to FIG. 2, and as described above, the sugarcane harvester 20 may include the main housing 40 defining the engine bay 42. The air inlet screen 44 of the main housing 40 may be positioned longitudinal between the power source 24 and the extractor 56, along a central longitudinal axis 76 of the sugarcane harvester 20. The central longitudinal axis 76 extends between a forward end and a rearward end of the sugarcane harvester 20. Depending upon ambient conditions, such as but not limited to wind speed and direction, debris discharged from the extractor 56, i.e., the leaf material, may accumulate between the air inlet screen 44 of the main housing 40 and the fan housing 64, on an engine deck or platform 106. Additionally, the debris may further accumulate on and cover the air inlet screen 44 and/or heat exchanger 28 of the main housing 40. For example, if the cooling fan 34 is configured to move air from the air inlet region 36, i.e., the exterior of the engine bay 42, toward and into the discharge region 38 i.e., the interior of the engine bay 42, it should be appreciated that the operation of the cooling fan 34 may operate to draw the debris up against the air inlet screen 44 and/or the heat exchanger 28. It should be appreciated that the primary cooling system 26 will not operate efficiently if the air inlet screen 44 becomes plugged with debris such that sufficient amounts of air to achieve the desired cooling of the power source 24 may not move through the air inlet screen 44.

As shown in FIG. 2, in order to reduce and/or prevent debris accumulation on the engine deck and/or on the air inlet screen 44, the sugarcane harvester 20 may be equipped with an inlet debris removal system 78. Generally, the inlet debris removal system 78 includes an auxiliary air pump 80 and a nozzle 82. The air pump 80 is operable to generate a flow of cleaning air 84. The nozzle 82 is positioned and configured to receive the flow of cleaning air 84 from the air pump 80 and direct the flow of cleaning air 84 across the inlet region 36 of the heat exchanger 28 and/or across the platform 106 adjacent the inlet region 36 for cleaning debris from the inlet region 36 and/or the platform 106 to maintain the flow of cooling air 32 across the heat exchanger 28. More particularly, in one implementation, the nozzle 82 may be positioned to direct the flow of cleaning air 84 across the air inlet screen 44 of the main housing 40. IN another implementation, the nozzle 82 may be positioned to direct the flow of cleaning air 84 across the platform 106 adjacent to the air inlet screen 44.

The auxiliary air pump 80 may be attached to and/or supported by the main frame 22 at a convenient location on the sugarcane harvester 20. The air pump 80 may be coupled to the nozzle 82 via an air duct 86 to move the flow of cleaning air 84 therebetween. The air pump 80 may moves ambient air through the air duct 86. The air pump 80 may alternatively be referred to as a fan or blower. The air pump 80 may be controlled to run continuously to provide a continuous flow of cleaning air 84 to the nozzle 82. In other implementations, the air pump 80 may be controlled to run intermittently so as to only provide the flow of cleaning air 84 on demand or at defined intervals. The air pump 80 may be driven or powered by, but is not limited to, electrical power, e.g., an electric fan, or hydraulic power, e.g., a hydraulic motor.

The heat exchanger 28 may be disposed within the engine bay 42 and behind the air inlet screen 44. The nozzle 82 may be disposed and/or positioned proximate and/or adjacent to an exterior of the engine bay 42, such as adjacent the air inlet region 36 of the heat exchanger 28. More particularly, the heat exchanger 28 may be disposed within the interior of the engine bay 42, and the nozzle 82 of the inlet debris removal system 78 may be disposed on the exterior of the engine bay 42, immediately adjacent to the air inlet screen 44, which defines and/or is located near the air inlet region 36 of the heat exchanger 28.

As described above, the air inlet screen 44 of the main housing 40 may be positioned between the power source 24 and the extractor 56 along the central longitudinal axis 76 of the main frame 22. As such, it should be appreciated that the heat exchanger 28 may also be positioned between the power source 24 and the extractor 56, adjacent the air inlet screen 44. In one implementation of the disclosure, the nozzle 82 may be positioned between the heat exchanger 28 and the extractor 56.

As described above, the inlet debris removal system 78 includes the air duct 86 connecting the air pump 80 and the nozzle 82. The air duct 86, may include, but is not limited to, a flexible pipe, a rigid pipe, or a combination of flexible and rigid pipes. The air duct 86 may be constructed from, but is not limited to, a plastic material, a metal material, a rubber or rubber-like material, or some other material capable of conducting the flow of cleaning air 84 and suitable for use on the sugarcane harvester 20.

The nozzle 82 may include an/or be defined by opening or open end of the air duct 86. In other implementations, the nozzle 82 be shaped and/or formed to direct the flow of cleaning in a specific direction. Additionally, the nozzle 82 may be formed and/or shaped to change flow characteristics of the flow of cleaning air 84. For example, the nozzle 82 may be shaped to control a velocity of the flow of cleaning air 84, or a pressure of the flow of cleaning air 84, or both. Additionally, it should be appreciated that the nozzle 82 may include a plurality of nozzle 82s. As such, while the nozzle 82 may be described herein as a singular device, it should be appreciated that the nozzle 82 may include multiple devices.

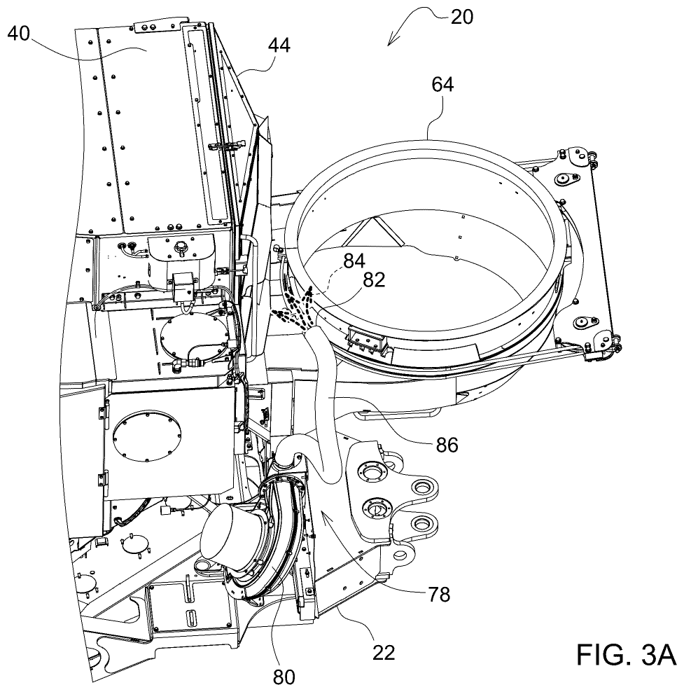

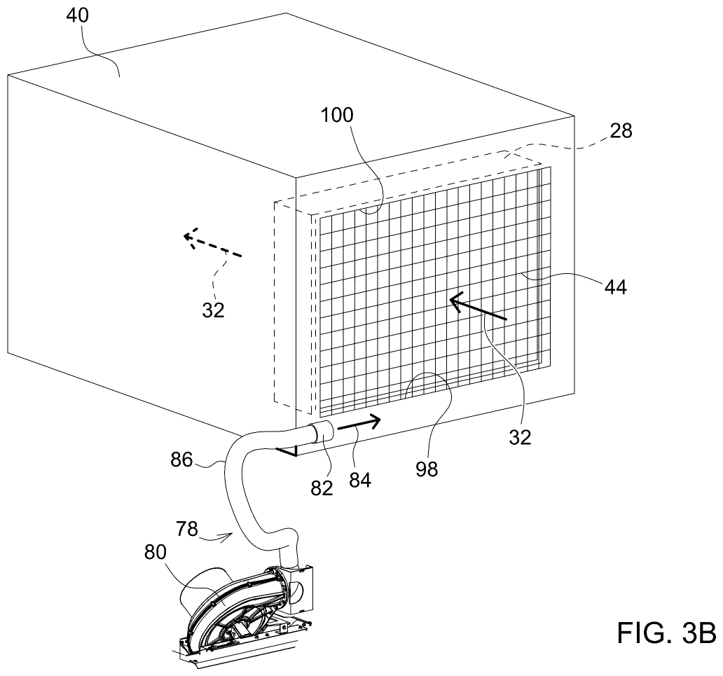

As noted above, the inlet debris removal system 78 may be implemented in many different configurations. Referring to FIGS. 3A and 3B, a first implementation of the inlet debris removal system 78 is shown. The implementation shown in FIGS. 3A and 3B include a singular nozzle 82 attached to a distal end of the air duct 86. The nozzle 82 of FIGS. 3A and 3B is positioned adjacent a lower left corner of the air inlet screen 44.

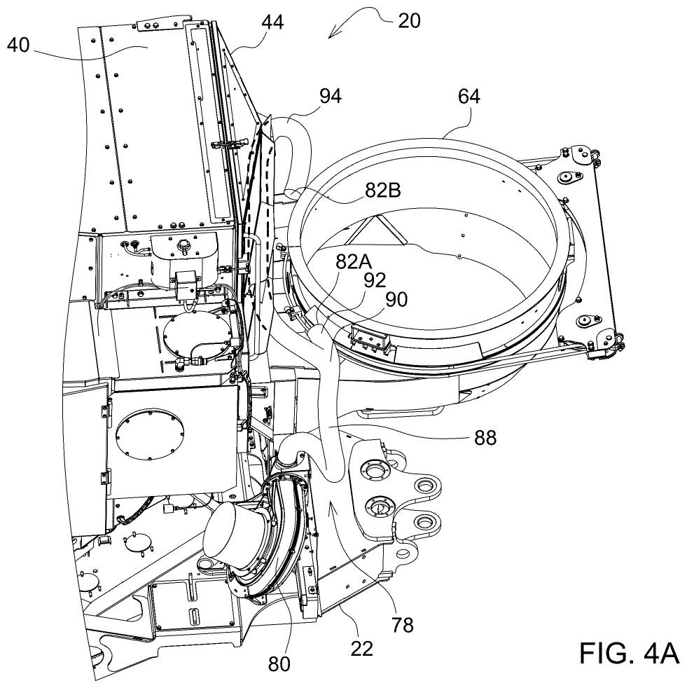

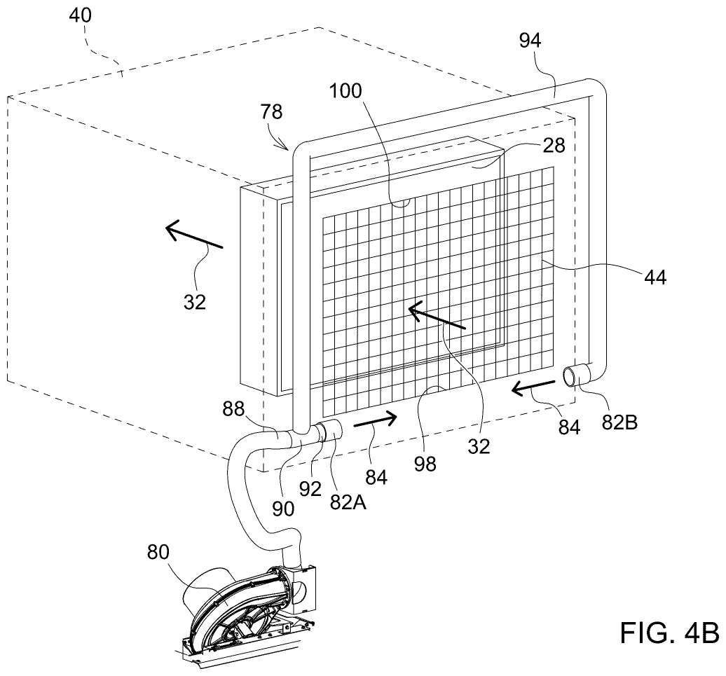

Referring to FIGS. 4A and 4B, a second implementation of the inlet debris removal system 78 is shown. The implementation shown in FIGS. 4A and 4B includes a first nozzle 82A and a second nozzle 82B. The air duct 86 includes a primary section 88 extending between the air pump 80 and a tee joint 90. The tee joint 90 bifurcates the air duct 86 into a left side supply section 92 and a right side supply section 94. The first nozzle 82A is attached to a distal end of the left side supply section 92. The first nozzle 82A is shown positioned adjacent a lower left corner of the air inlet screen 44. However, it should be appreciated that the first nozzle 82A may be positioned at some other location along the left side of the air inlet screen 44. The second nozzle 82B is attached to a distal end of the right side supply section 94. The second nozzle 82B is shown positioned adjacent a lower right corner of the air inlet screen 44. However, it should be appreciated that the second nozzle 82B may be positioned at some other location along the right side of the air inlet screen 44.

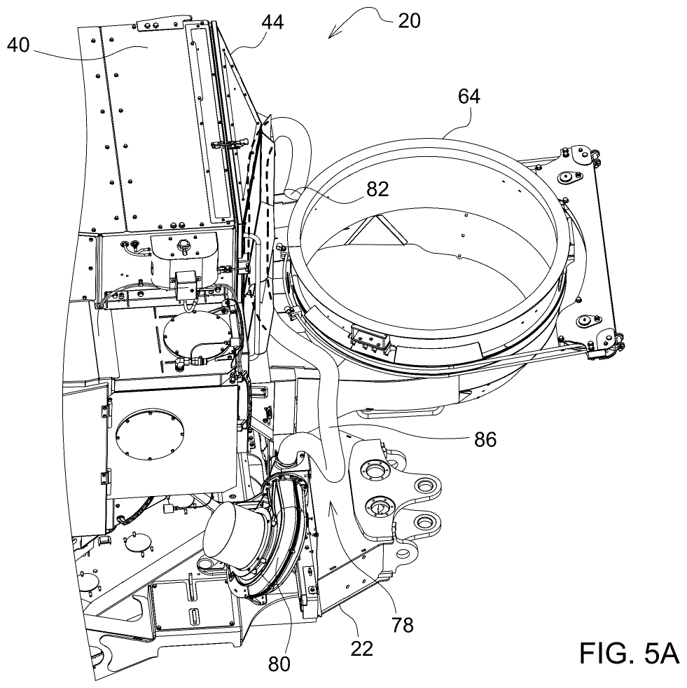

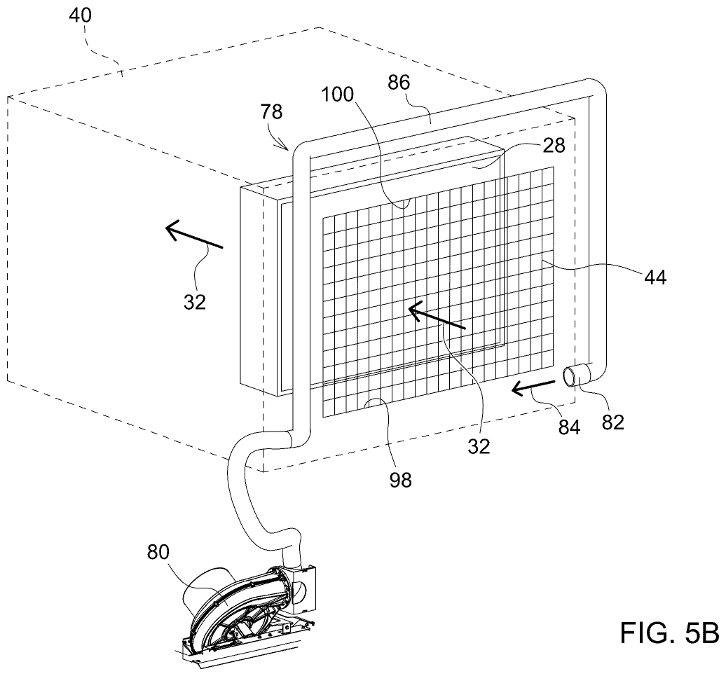

Referring to FIGS. 5A and 5B, a third implementation of the inlet debris removal system 78 is shown. The implementation shown in FIGS. 5A and 5B includes a singular nozzle 82 attached to a distal end of the air duct 86. The nozzle 82 of FIGS. 5A and 5B is positioned adjacent a lower right corner of the air inlet screen 44.

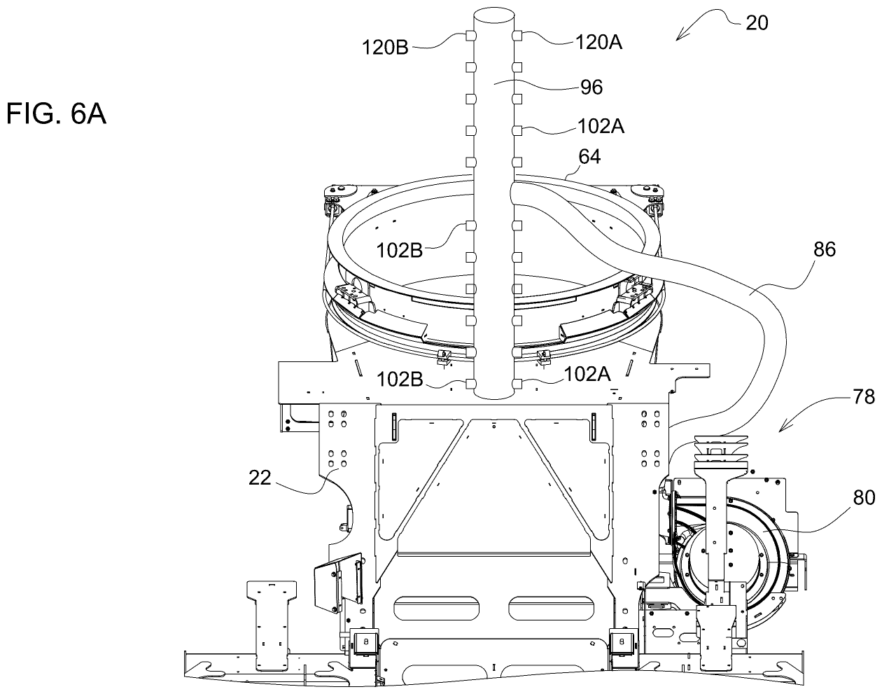

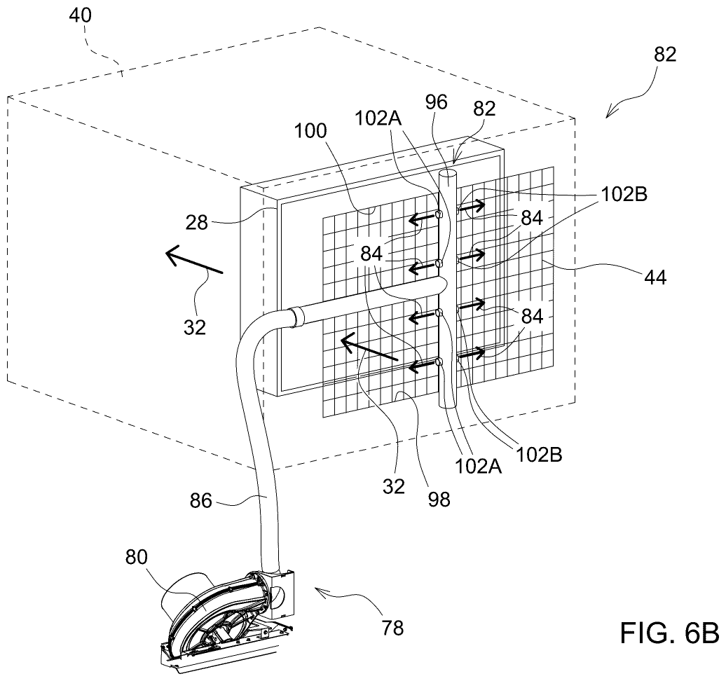

Referring to FIGS. 6A and 6B, a fourth implementation of the inlet debris removal system 78 is shown. The implementation shown in FIGS. 6A and 6B includes a tubular manifold 96 extending substantially vertically. The tubular manifold 96 may be positioned at an approximate lateral midsection of the heat exchanger 28, and extends from an approximate lower edge 98 of the air inlet screen 44 up to an approximate upper edge 100 of the air inlet screen 44. The air duct 86 is shown connecting to the tubular manifold 96 at an approximate midsection of the tubular manifold 96. However, it should be appreciated that the air duct 86 may alternatively connect to a lower end of the tubular manifold 96 or an upper end of the tubular manifold 96. The tubular manifold 96 includes a plurality of air jets 102 arranged to direct the flow of cleaning air 84 laterally across the inlet region 36 of the heat exchanger 28 relative to the central longitudinal axis 76 of the frame. In one implementation, the plurality of air jets 102 includes a first group of jets 102A directing the flow of cleaning air 84 toward a first lateral side of the main frame 22, i.e., a left side of the main frame 22, and a second group of jets 102B directing the flow of cleaning air 84 toward a second lateral side of the frame, i.e., the right side of the main frame 22.

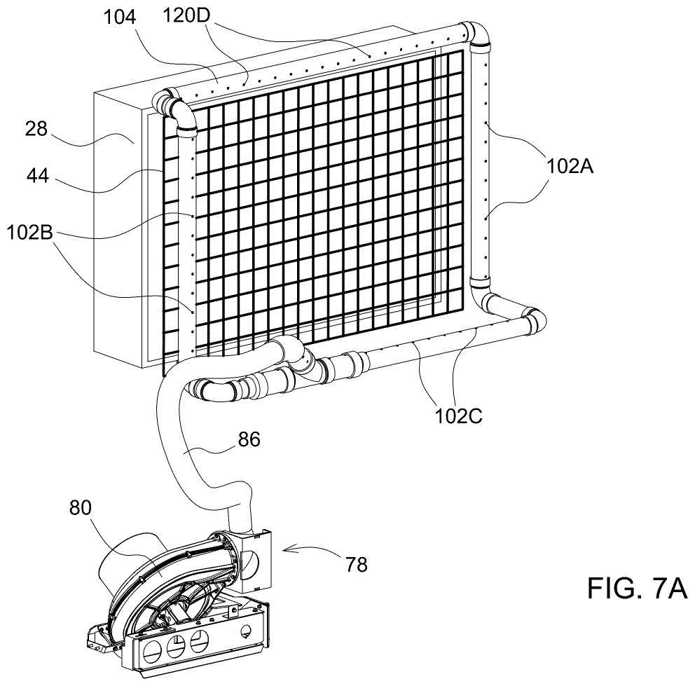

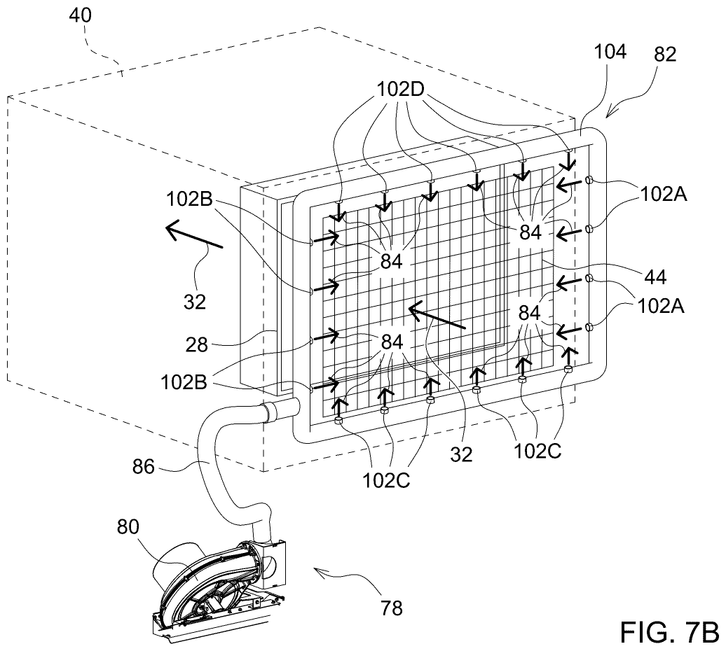

Referring to FIGS. 7A and 7B, a fifth implementation of the inlet debris removal system 78 is shown. The implementation shown in FIGS. 7A and 7B includes a manifold surround 104 extending around a circumference of the air inlet region 36 of the heat exchanger 28. The air duct 86 connects the air pump 80 to the manifold surround 104. The manifold surround 104 includes a plurality of air jets 102 arranged to direct the flow of cleaning air 84 laterally across the inlet region 36 of the heat exchanger 28 relative to the central longitudinal axis 76 of the frame. The plurality of air jets 102 may include a first group of jets 102A arranged to direct the flow of cooling air 32 from right to left across the air inlet screen 44, a second group of jets 102B arranged to direct the flow of cooling air 32 from left to right across the air inlet screen 44, a third group of jets 102C arranged to direct the flow of cooling air 32 from bottom to top across the air inlet screen 44, and/or a fourth group of jets 102D arranged to direct the flow of cooling air 32 axially along the central longitudinal axis 76 of the main frame 22, over an upper edge 100 of the air inlet screen 44.

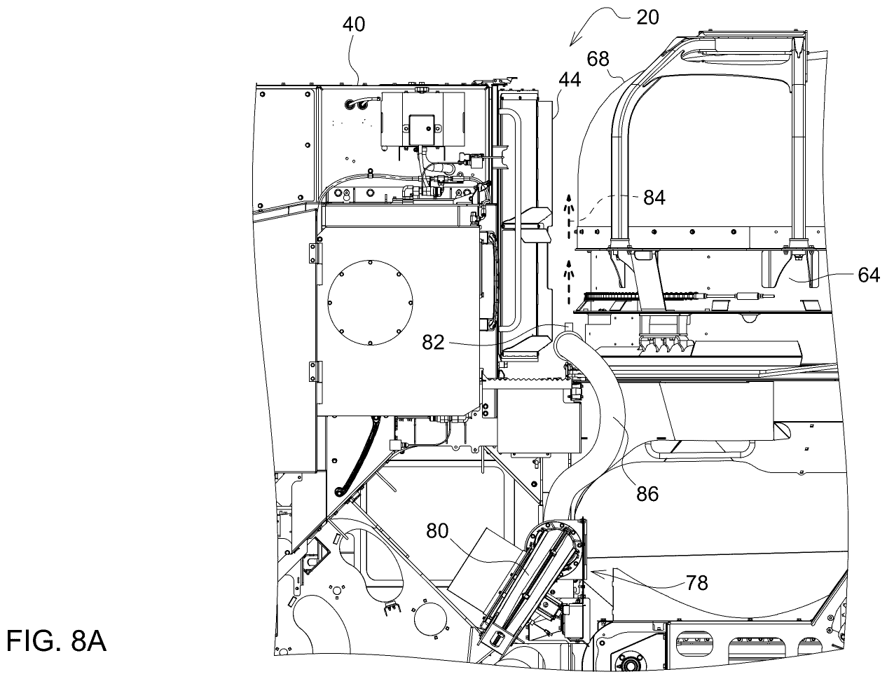

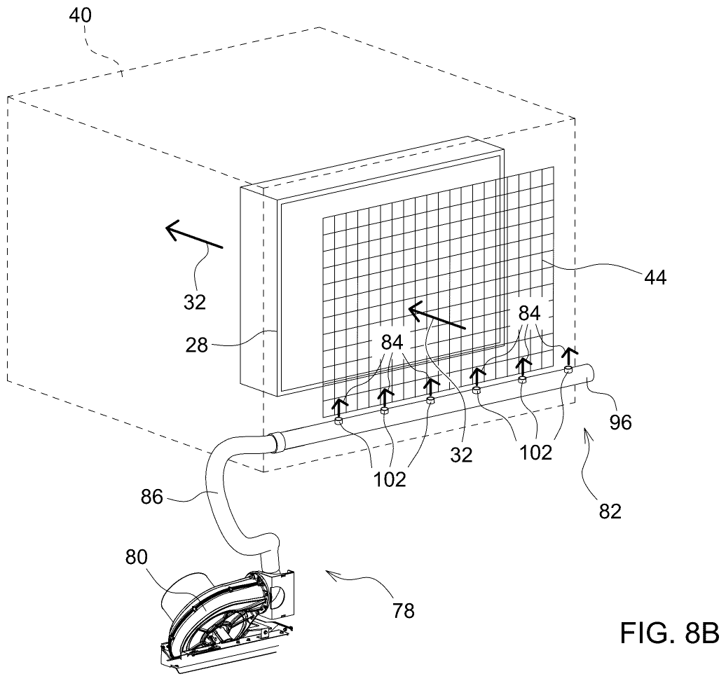

Referring to FIGS. 8A and 8B, a sixth implementation of the inlet debris removal system 78 is shown. The implementation shown in FIGS. 8A and 8B includes a tubular manifold 96 extending laterally across a width of the heat exchanger 28 and the air inlet screen 44. The tubular manifold 96 is disposed adjacent the lower edge 98 of the air inlet screen 44, and is arranged to extend transversely relative to the central longitudinal axis 76 of the main frame 22. The tubular manifold 96 may include a plurality of air jets 102 arranged to direct the flow of cleaning air 84 vertically upward across the inlet region 36 of the heat exchanger 28. In one implementation, the tubular manifold 96 is disposed at an elevation vertically below the lower edge 98 of the heat exchanger 28.

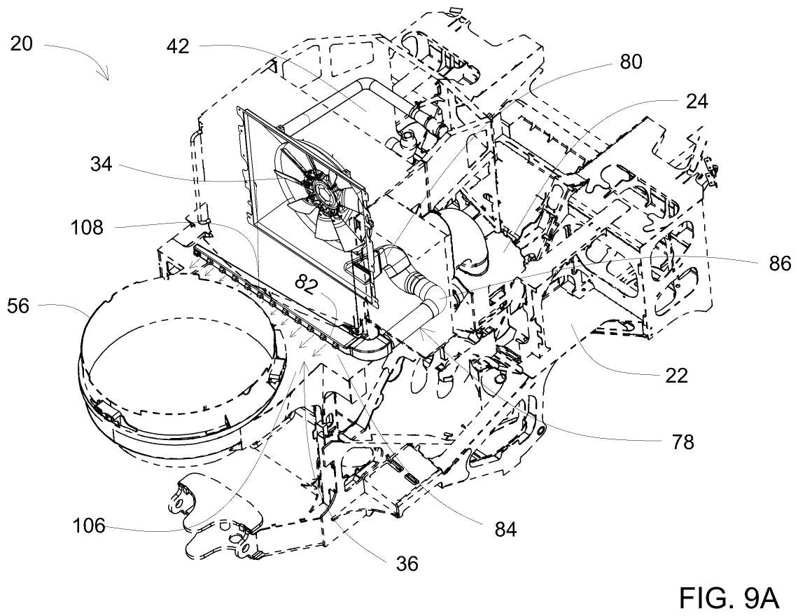

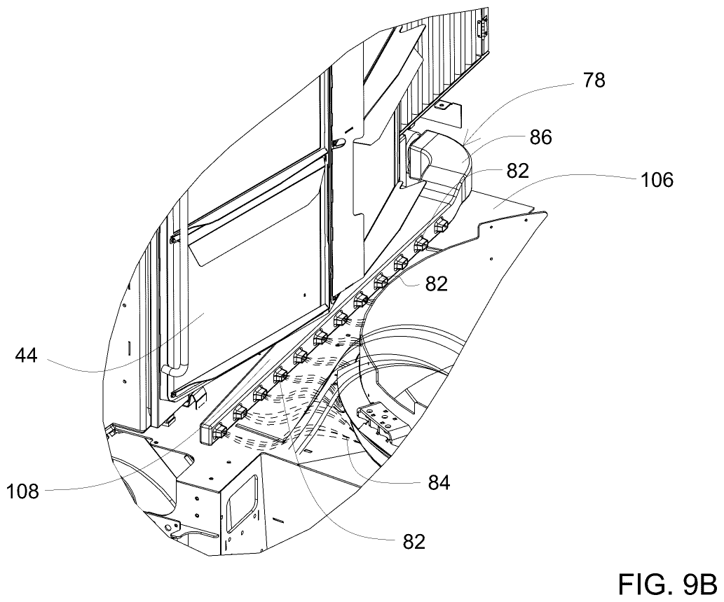

Referring to FIGS. 9A and 9B, a seventh implementation of the inlet debris removal system 78 is shown. The implementation shown in FIGS. 9A and 9B includes the air pump 80 disposed within the engine bay, behind the cooling fan 34. The duct 86 extends around and is coupled to a tapered manifold 108, which is positioned adjacent a lower or bottom edge of the inlet region 36, extending transversely across the platform 106. The tapered manifold 108 includes a plurality of nozzles 82 arranged to direct the flow of cleaning air 84 across the platform 106.

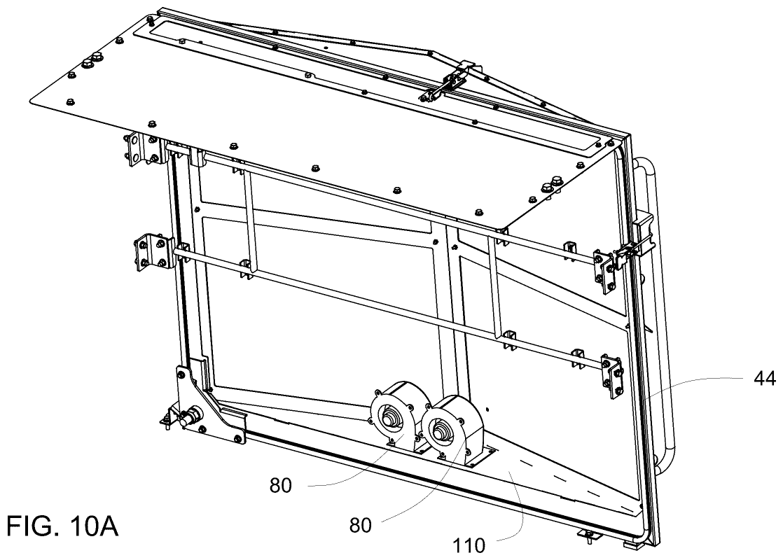

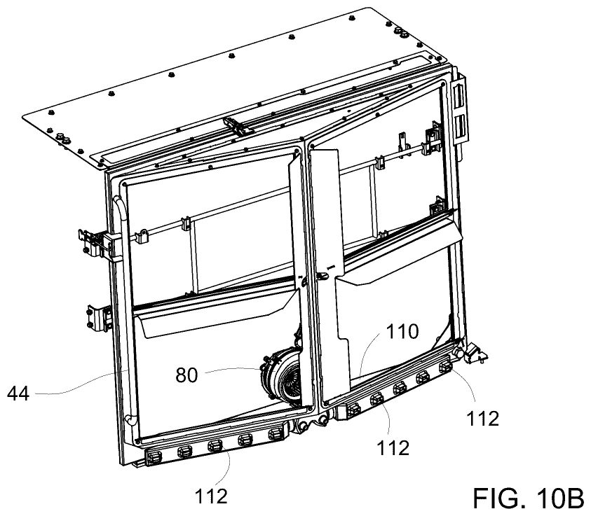

Referring to FIGS. 10A and 10B, an eight implementation of the inlet debris removal system 78 is shown. The implementation shown in FIGS. 10A and 10B includes a pair of air pumps 80A, 80B disposed within the engine bay, directly behind the air inlet screen 44. The pair of air pumps 80A, 80B, exhaust the flow of cleaning air 84 downward through a plenum 110 positioned adjacent a bottom edge of the air inlet screen 44. The plenum 110 includes an outlet 112 arranged to direct the flow of cooling air across the platform 106 for cleaning the platform 106.

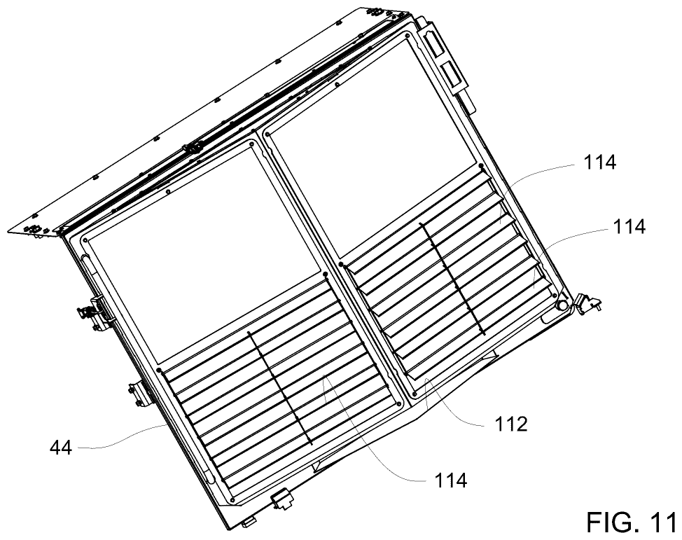

Referring to FIG. 11, another implementation may include the air inlet screen 44 having a plurality of louvers 114. The louvers 114 may be selectively controllable to open or close air flow through the air inlet screen 44. For example, a lower portion of the air inlet screen 44 may be equipped with the louvers 114. The louvers may be controlled to an open position to allow air movement through the air inlet screen 44 for cooling the power source 24, and may be moved to a closed position for cleaning the platform 106 without collecting debris on the portion of the air inlet screen 44 covered by the louvers 114.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A sugarcane harvester comprising:
a main frame;
a power source supported on the main frame and operable to generate torque;
a primary cooling system including a heat exchanger, wherein the primary cooling system is operable to circulate a coolant through the power source for absorbing heat from the power source, and circulate the coolant through the heat exchanger for transferring heat from the coolant to a flow of cooling air moving across the heat exchanger from an inlet region to a discharge region;
an inlet debris removal system having an air pump and a nozzle, wherein the air pump is operable to generate a flow of cleaning air, and wherein the nozzle is configured to receive the flow of cleaning air from the air pump and direct the flow of cleaning air across the inlet region of the heat exchanger for cleaning debris from the inlet region to maintain the flow of cooling air across the heat exchanger.

2. The sugarcane harvester set forth in claim 1, further comprising a main housing defining an engine bay and covering the power source and including an air inlet screen defining the inlet region of the heat exchanger.

3. The sugarcane harvester set forth in claim 2, wherein the nozzle is positioned to direct the flow of cleaning air across air inlet screen.

4. The sugarcane harvester set forth in claim 2, wherein the main housing includes a platform disposed proximate the air inlet screen in the inlet region of the heat exchanger.

5. The sugarcane harvester set forth in claim 4, wherein the nozzle is positioned to direct the flow of cleaning air across the platform.

6. The sugarcane harvester set forth in claim 2, wherein the heat exchanger is disposed within the engine bay, and wherein the nozzle is disposed proximate an exterior of the engine bay.

7. The sugarcane harvester set forth in claim 1, further comprising a chopper having a drum configured for cutting stalks of sugarcane into billets.

8. The sugarcane harvester set forth in claim 7, further comprising an extractor having a fan assembly for separating leaf material from the billets, wherein the extractor includes a hood moveable relative to the main frame, and wherein the hood includes an exhaust outlet that is selectively positionable relative to the main frame for discharging the leaf material from the extractor in a desired direction.

9. The sugarcane harvester set forth in claim 8, wherein the heat exchanger is positioned between the power source and the extractor.

10. The sugarcane harvester set forth in claim 9, wherein the nozzle is positioned between the heat exchanger and the extractor.

11. The sugarcane harvester set forth in claim 1, wherein the inlet debris removal system includes a duct connecting the air pump and the nozzle.

12. The sugarcane harvester set forth in claim 11, wherein the nozzle includes a tubular manifold extending substantially vertically and a plurality of air jets arranged to direct the flow of cleaning air laterally across the inlet region of the heat exchanger relative to a central longitudinal axis of the frame.

13. The sugarcane harvester set forth in claim 12, wherein the tubular manifold is positioned at an approximate lateral midsection of the heat exchanger.

14. The sugarcane harvester set forth in claim 13, wherein the plurality of air jets includes a first group of jets directing the flow of cleaning air toward a first lateral side of the main frame, and a second group of jets directing the flow of cleaning air toward a second lateral side of the main frame.

15. The sugarcane harvester set forth in claim 11, wherein the nozzle includes a tubular manifold surround extending around a circumference of the air inlet region of the heat exchanger.

16. The sugarcane harvester set forth in claim 11, wherein the nozzle includes a tubular manifold extending laterally across a width of the heat exchanger, and including a plurality of air jets arranged to direct the flow of cleaning air vertically upward across the inlet region of the heat exchanger.

17. The sugarcane harvester set forth in claim 16, wherein the tubular manifold is disposed at an elevation vertically below a lower edge of the heat exchanger.

18. The sugarcane harvester set forth in claim 1, wherein the air pump includes a first air pump and a second air pump.

19. The sugarcane harvester set forth in claim 1, wherein the air pump is positioned within an engine bay enclosing the power source.
